(19) United States
(12) Patent Application Publication
(10) Pub. No.: US 2005/0106945 A1
(43) Pub. Date: May 19, 2005

(54) Junction connector and connection structure between wire-harnesses using the junction connector

(76) Inventors: Katsuhiro Suzuki, Aichi-ken (JP); Tadashi Honda, Shizuoka-ken (JP); Nobutoshi Hagiwara, Ann Arbor, MI (US); Katsuhiro Mishima, Aichi-ken (JP)

Correspondence Address: Finnegan, Henderson, Farabow,;Garrett & Dunner, L.L.P., 1300 I Street, N.W., Washington, DC, 20005-3315, US

(21) Appl. No.: 10/954,492

(22) Filed: Oct. 1, 2004

(30) Foreign Application Priority Data
Oct. 3, 2003 (JP) P2003-345782

(51) Int. Cl. H01R 13/58

(52) U.S. Cl. 439/655

(57) ABSTRACT

A junction connector includes a first connector-fitting chamber configured to mate with first connectors. The first connector-fitting chamber has first male terminals connected to first female terminals of the first connectors, respectively. The junction connector includes a second connector-fitting chamber configured to mate with second connectors. The second connector-fitting chamber has second male terminals connected to second female terminals of the second connectors, respectively. The first male terminals and the second male terminals are connected to each other.

### CROSS-REFERENCE TO RELATED APPLICATIONS

This application is based upon and claims the benefit of priority from Japanese Patent Application No. 2003-345782 filed on Oct. 3, 2003; the entire contents of which are incorporated herein by reference.

### BACKGROUND OF THE INVENTION

The present invention relates to a junction connector that connects wire-harnesses each having a bundle of electric wires, and relates to a connection structure between the wire-harnesses using the junction connector.

Wire-harnesses disposed in a vehicle are fabricated in a wire-harness fabricating plant. The fabricated wire-harnesses are disposed in the vehicle in a vehicle-assembly plant, and then connected to each other, forming a predetermined circuit. The wire-harness fabricating plant ships wire-harnesses having a structure which allows the vehicle-assembly plant to swiftly and easily connect the wire-harnesses to each other (Refer to Japanese Utility Model Application Laid-open No. S62-131387).

### SUMMARY OF THE INVENTION

The present invention is directed to a junction connector, a connection structure between wire-harnesses using the junction connector, which facilitate the connection operation of a first connector and a second connector, and which requires a small space for the connection structure, and which does not require any measures to ensure the quality assurance in terminal.

The first aspect of the invention provides the following junction connector. The junction connector includes a first connector-fitting chamber configured to mate with first connectors. The first connector-fitting chamber has first male terminals connected to first female terminals of the first connectors, respectively. The junction connector includes a second connector-fitting chamber configured to mate with second connectors. The second connector-fitting chamber has second male terminals connected to second female terminals of the second connectors, respectively. The first male terminals and the second male terminals are connected to each other.

At least one of the first connectors and the second connectors are assembled to each other.

The second aspect of the invention provides the following connection structure between wire-harnesses. The connection structure includes first connectors connected to a first harness and having first female terminals. The connection structure includes second connectors connected to a second harness and having second female terminals. The connection structure includes a junction connector connecting between the first and second connectors. The junction connector includes a first connector-fitting chamber mated with the first connectors. The first connector has first male terminals connected to the first female terminals. The junction connector includes a second connector-fitting chamber mated with the second connectors. The first connector has second male terminals connected to the second female terminals. The first and second male terminals are connected to each other.

At least one of the first connectors and second connectors are assembled to each other.

### BRIEF DESCRIPTION OF THE ACCOMPANYING DRAWINGS

FIG. 1A is a cross sectional view of a junction connector according to a first embodiment of the present invention;

FIG. 1B is a vertical sectional view of the junction connector taken along a line IB-IB in FIG. 1A;

FIG. 2A is a schematic plan view of wire-harnesses according to the first embodiment;

FIG. 2B is a sectional view taken along a line IIB-IIB in FIG. 2A;

FIG. 3 is a schematic plan view for illustrating a process of fabrication of the wire-harnesses in FIG. 2A;

FIG. 4 is a schematic plan view for illustrating a process of connection of the wire-harnesses in FIG. 2A;

FIG. 5 is a sectional view taken along a line V-V in FIG. 4;

FIG. 6 is a schematic plan view for illustrating a process of connection of wire-harnesses according to a second embodiment of the present invention; and

FIGS. 7A and 7B are diagrams for illustrating benefits according to the second embodiment of the present invention, wherein FIG. 7A is a schematic plan view of a wire-harness including three second connectors, and FIG. 7B is a schematic plan view of a wire-harness including two second connectors.

### DETAILED DESCRIPTION OF THE PREFERRED EMBODIMENTS

The following describes the embodiments of the present invention with reference to the accompanying drawings.

### First Embodiment

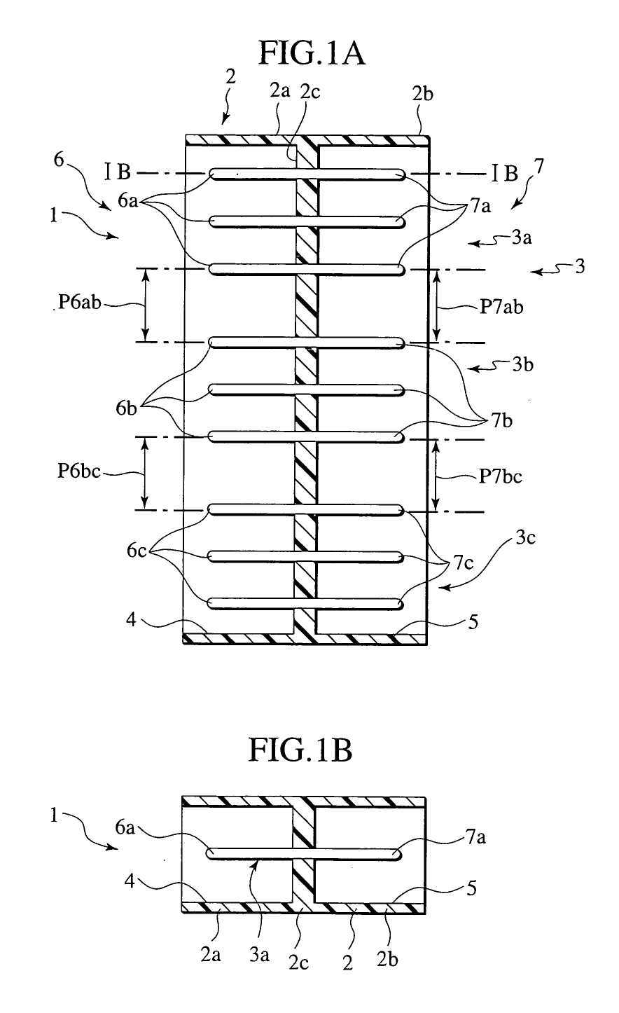

A junction connector 1 used in a wire-harness connection structure will be described first. With reference to FIGS. 1A and 1B, the junction connector 1 includes a box-shaped and synthetic resinous connector housing 2, and a large number of contact pins 3. The connector housing 2 includes a first housing 2a defining a first connector-fitting chamber 4 which opens at one surface of the connector housing 2. The connector housing 2 includes a second housing 2b opposite to the first housing 2a. The second housing 2b defines a second connector-fitting chamber 5 which opens at the opposite surface to the one surface of the connector housing 2. The connector housing 2 includes a partition 2C between the first and second connector-fitting chamber 4, 5. The first connector-fitting chamber 4 has later-described first connectors 10 to be fitted thereinto. The second connector-fitting chamber 5 has later-described second connectors 11 to be fitted thereinto. Each of the contact pins 3 has opposite sides with respect to the center thereof. The opposite sides protrude into the first connector-fitting chamber 4 and the second connector-fitting chamber 5, respectively. The opposite sides have portions protruding into the first connector-fitting chamber 4, serving as male terminals 6. The opposite sides have portions protruding into the second connector-fitting chamber 5, serving as second male terminals 7. The first male terminals 6 and the second male terminals 7 are electrically conducted, with the terminals 6 and 7 located at the identical positions.

The three sets of first male terminals 6 have equal pitches between the neighboring first male terminals 6a, 6b, 6c, respectively. The neighboring first male terminals 6a, 6b have a pitch P6ab therebetween. The neighboring first male terminals 6b, 6c have a pitch P6bc therebetween. The three sets of second male terminals 7 have equal pitches between the neighboring second male terminals 7a, 7b, 7c, respectively. The neighboring second terminals 7a, 7b have a pitch P7ab therebetween. The neighboring second terminals 7b, 7c have a pitch P7bc therebetween.

The following describes the first connectors 10 and the second connectors 11, which connect to a first wire-harness WH1 and a second wire-harness WH2 to be connected to each other, respectively.

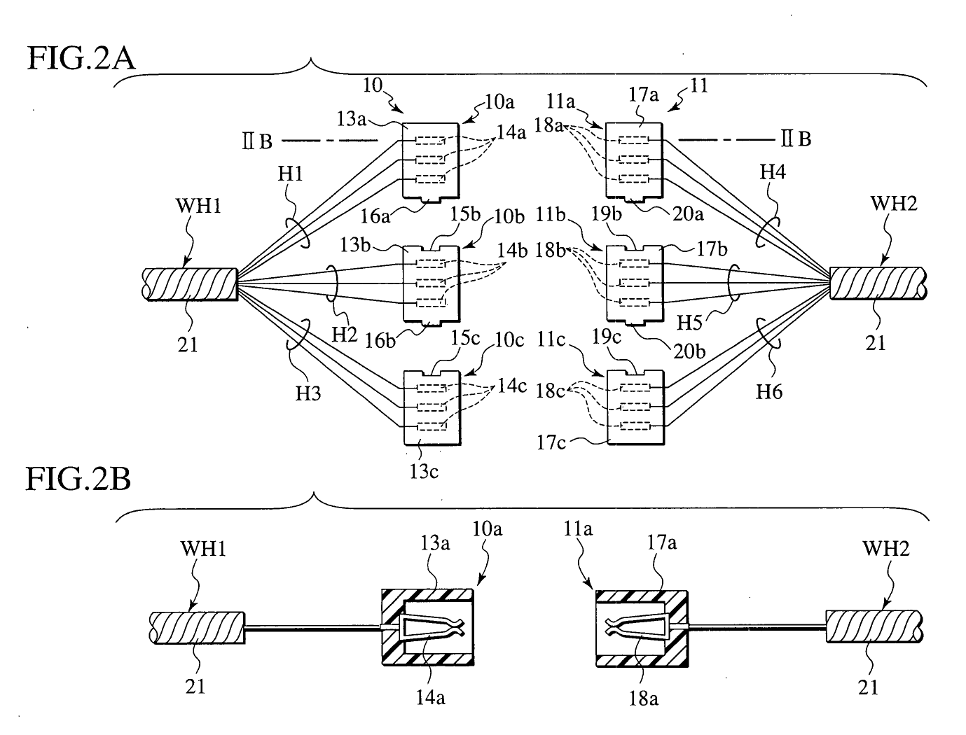

With reference to FIGS. 2A and 2B, the first wire-harness WH1 includes an end connected to three first connectors 10a, 10b, 10c. The first connectors 10a to 10c include female terminals 14a, 14b, 14c in a connector housing 13a, 13b, 13c, respectively. The female terminals 14a to 14c are covered with the connector housing 13a to 13c, respectively. The connector housings 13a, 13b appropriately include concave engagement sections 15b, 15c, respectively. The connector housings 13a, 13b include convex engagement sections 16a, 16b, respectively. The concave and convex engagement sections 15b, 16a are fitted to connect to the first connectors 10a, 10b. The concave and convex engagement section 15c, 16b are fitted to connect to the first connectors 10b, 10c. The set of concave and convex engagement section 15b, 16a may be different from the set of concave and convex engagement section 15c and 16b in shape or location, which prevents an incorrect connection among the first connectors 10a to 10c.

The second wire-harness WH2 has an end connected to three second connectors 11a, 11b, 11c. Like the first connectors 10, the second connectors 11a to 11c have female terminals 18a, 18b, 18c in connector housings 17a, 17b, 17c, respectively. The female terminals 18a to 18c are covered with the connector housings 17a to 17c, respectively. The connector housings 17b, 17c include concave engagement sections 19b, 19c, respectively. The connector housing 17a, 17b include convex engagement sections 20a, 20b, respectively. The concave and convex engagement sections 19b, 20a are fitted to connect to the second connectors 11a, 11b. The concave and convex engagement section 19c and 20b are fitted to connect to the second connectors 11b, 11c. The set of concave and convex engagement section 19b and 20a may be different from the set of concave and convex engagement sections 19c, 20b in shape or location, which prevents an incorrect connection among the second connectors 11a to 11c.

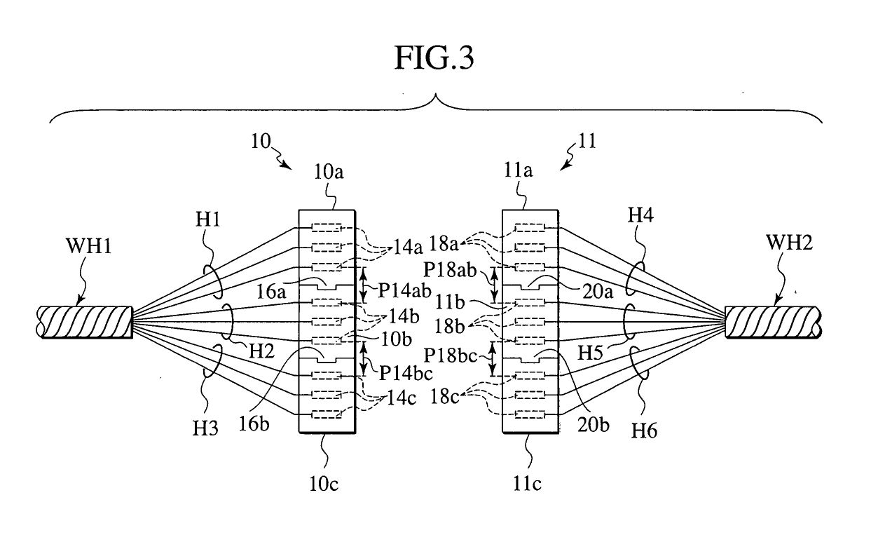

With reference to FIG. 3, the three sets of female terminals 14a, 14b, 14c have equal pitches between the neighboring female terminals 14a, 14b, 14c, respectively. The neighboring female terminals 14a, 14b have a pitch P14ab therebetween that is equal to the pitch P6ab. The neighboring female terminals 14b, 14c have a pitch P14bc therebetween that is equal to the pitch P6bc. The three sets of female terminals 18a, 18b, 18c have equal pitches between the neighboring female terminals, respectively. The neighboring female terminals 18a, 18b have a pitch P18ab therebetween that is equal to the pitch P7ab. The neighboring female terminals 18b, 18c have a pitch P18bc therebetween that is equal to the pitch P7bc.

With reference to FIGS. 2A to 5, the following describes a procedure from fabricating operation of the first and the second wire-harnesses WH1 and WH2 to the connection process between the wire-harnesses WH1 and WH2. In the connection structure between the wire-harnesses WH1 and WH2, the first and the second wire-harnesses WH1 and WH2 to be connected to each other include three sub-harnesses H1 to H3 and H4 to H6, respectively. The sub-harnesses H1 to H3 and H4 to H6 have ends, which were previously connected to female terminals 14a to 14c and 18a to 18c.

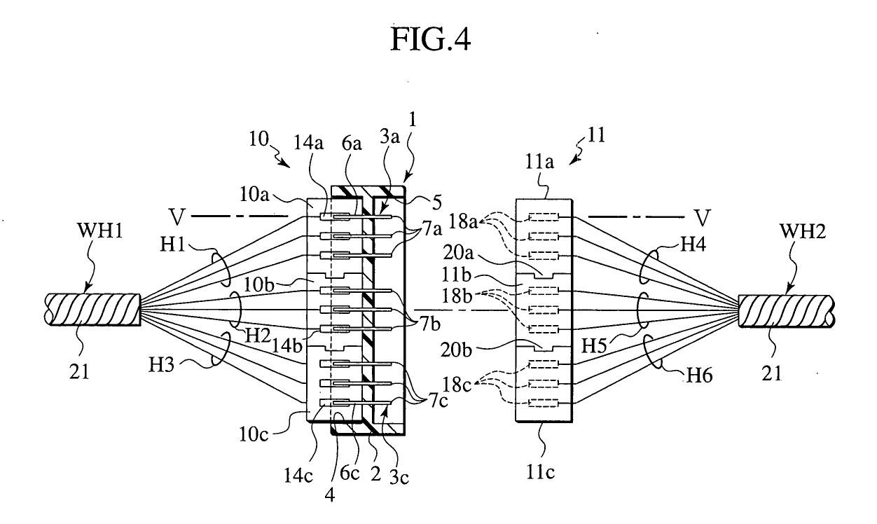

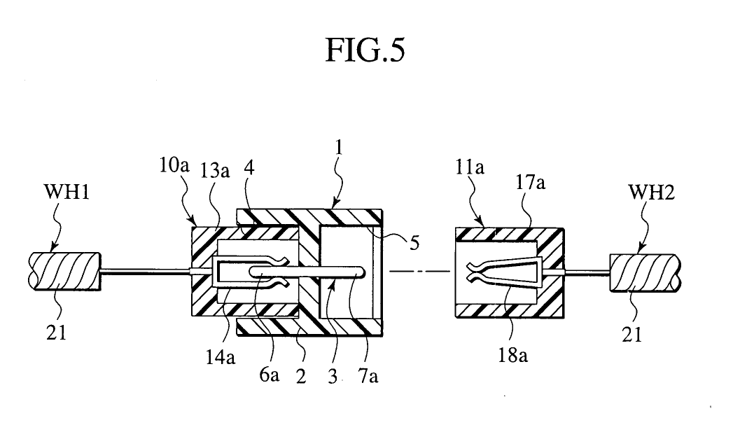

With reference to FIGS. 2A and 2B, the ends of the sub-harnesses H1 to H3 are mounted to the first connectors 10a to 10c in the wire-harness fabricating plant. The sub-harnesses H1 to H3 are bundled and secured to each other by means of an adhesive tape 21. With reference to FIG. 3, the first connectors 10a to 10c are assembled to one another, using two sets of concave and convex engagement sections 15b, 16a and 15c, 16b. With reference to FIGS. 4 and 5, the assembled first connectors 10a to 1oc are fitted into the first connector-fitting chamber 4 of the junction connector 1. This fitting allows the first connectors 10a to 10c to be mounted to the junction connector 1. The male terminals 6a, 6b, 6c of the connector pins 3a, 3b, 3c are inserted into the female terminals 14a, 14b, 14c, respectively. This produces the first wire-harness WH1.

In FIGS. 2A and 2B, the ends of the sub-harnesses H4 to H6 are mounted to the second connectors 11a to 11c, respectively. The sub-harnesses H4 to H6 are bundled and secured to each other by means of an adhesive tape 21. In FIG. 3, the second connectors 11a to 11c are assembled to one another, using two sets of concave and convex engagement sections 19b, 20a and 19c, 20b, thereby producing the second wire-harness WH2.

The completed first and second wire-harnesses WH1, WH2 are transferred to the vehicle-body assembly plant. In the vehicle-body assembly plant, either before or after the first and second wire-harnesses WH1, WH2 are disposed in a vehicle, the second connectors 11a to 11c are fitted into the second connector-fitting chamber 5 of the junction connector 1 on the side of the first wire-harness WH1. The male terminals 7a, 7b, 7c of the contact pins 3a, 3b, 3c are inserted into the female terminals 18a, 18b, 18c, respectively. This procedure establishes electrical connection between the first wire-harness WH1 and the second wire-harness WH2.

In the wire-harness fabricating plant, the junction connector 1 was mounted to the first connectors 10a to 10c. The junction connector 1 may be mounted to the second connectors 11a to 11c instead of the first connectors 10a to 10c.

According to the junction connector 1 and the connection structure for connecting the wire-harnesses WH1, WH2 using the junction connector 1, the first connectors 10 and the second connectors 11 are connected to the ends of the first and the second wire-harnesses WH1, WH2 in the wire-harness fabricating plant, respectively. One of the first connectors 10 and the second connectors 11 are fitted into the corresponding one of the first connector-fitting chamber 4 and the second connector-fitting chamber 5 of the junction connector 1. The first wire-harness WH1 and the second wire-harness WH2 are transferred to the vehicle-body assembly plant, with one of the wire-harnesses WH1, WH2 mounted to the junction connector 1. In the vehicle-body assembly plant, the other of the first connectors 10 and the second connectors 11 are fitted into the vacant one of the first and second connector-fitting chambers 4, 5 of the junction connector 1. This procedure completes the connection operation for the connectors.

Thus, one of the first connectors 10 and the second connectors 11 are integrated together by means of the junction connector 1. The other of the first connectors 10 and the second connectors 11 may be connected to the junction connector 1. This procedure facilitates the connection operation for the connectors.

The first and the second connectors 10a to 10c, 11a to 11c include the male terminals 14a to 14c, 18a to 18c, respectively. This structure does not required hoods to be added for the protection of the male terminals to the connector housings 13a to 13c, 17a to 17c. This reduces the first and the second connectors 10a to 10c, 11a to 11c in size, thus rendering a small space sufficient for the connector-connection structure. Both the first and the second connectors 10a to 10c and 11a to 11c have male terminals 14a to 14c and 18a to 18c, which do not require operation for ensuring quality assurance.

In the first embodiment, the first connectors 10 and the second connectors 11 are assembled to each other, respectively. In the vehicle-body assembly plant, one of the assembled first connectors 10a to 10c and the assembled second connectors 11 a to 11c are fitted into the corresponding one of the first and the second connector-fitting chambers 4 and 5, thus completing the operation. This completes the connector-connection operation in the wire-harness assembly plant in one process, thus facilitating the connector-connection operation. The first connectors 10 or the second connectors 11 may not be assembled to one another.

The first connectors 10 and the second connectors 11 of respective identical parts enhance the efficiency of the connector-connection operation, and reduce the number of kinds of parts.

### Second Embodiment

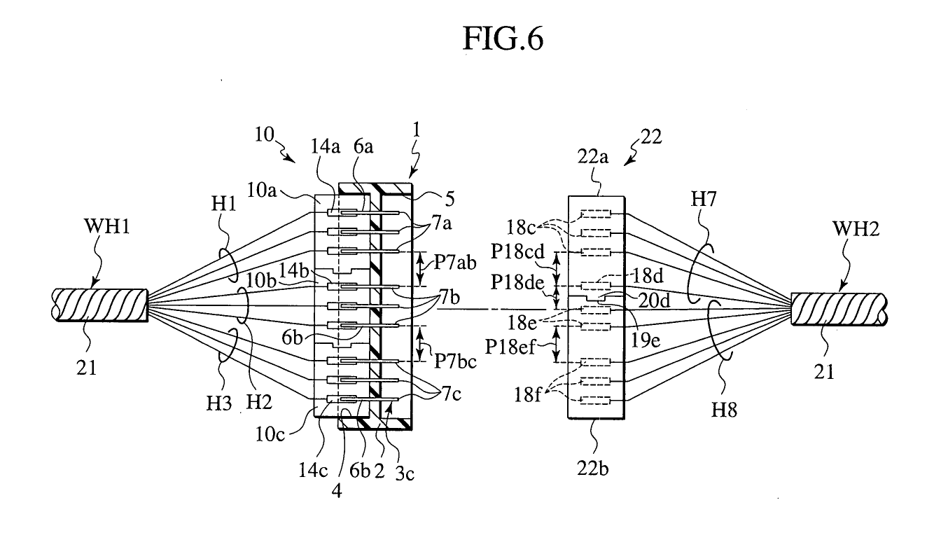

With reference to FIG. 6, the second wire-harness WH2 has an end connected to two second connectors 22a, 22b. Each of the second connectors 22a, 22b has a greater width and more female terminals 18c to 18f as compared with the second connectors 11a to 11c of the first embodiment. Other structures of the second embodiment are identical with those of the first embodiment, therefore, like members are designated by like reference numerals and a detailed description therefore is omitted.

The second embodiment is different from the first embodiment in that the two second connectors 22a, 22b are connected to the end of the second wire-harness WH2. The procedure from the fabricating process of the first and the second wire-harnesses WH1, WH2 to the connection process between the wire-harnesses WH1, WH2 is substantially identical to that of the first embodiment. The second embodiment facilitates the connection operation between the first and the second connectors 10, 22, rendering a small space sufficient for the connection structure, without any measures to ensure the quality assurance of the terminals.

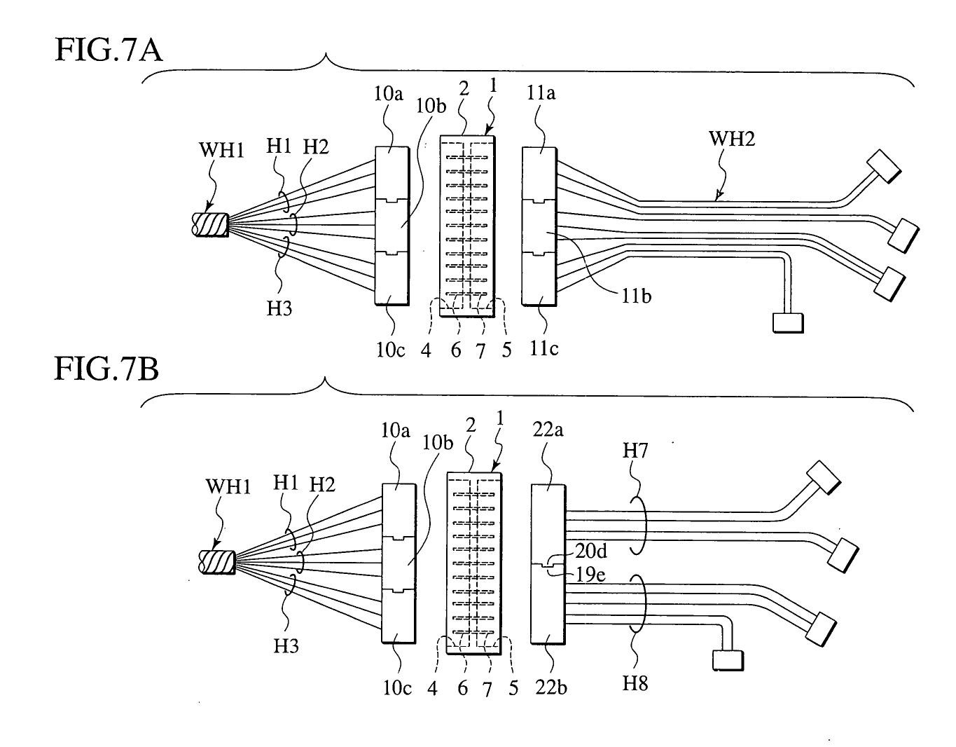

In the second embodiment, the first and second wire-harness WH1, WH2 are different from each other in the number of connectors. The first wire-harness WH1 includes the first connectors 10a to 10c (three sub-harnesses). The second wire-harness WH2 includes the second connectors 22a, 22b (two sub-harnesses). The following describes the reason. The first wire-harness WH1 and the second wire-harness WH2 do not coincide with each other occasionally, in terms of the number of the easily-handled sub-harnesses. The first and second connectors 10a to 10c, 11a to 11c are identical to each other by the number of connectors in spite of the different number of easily-handled sub-harnesses. This allows for the formation of one sub-harness (multi-circuit) for the entire second wire-harness WH2 as shown in FIG. 7A. This requires the second wire-harness WH2 (sub-harness) to be handled with difficulty. Thus, with reference to FIG. 7B, the second wire-harness WH2 is separated into two easily-handled sub-harnesses H7, H8 (small circuits). Respective ends of the sub-harnesses H7, H8 are connected to the second connectors 22a, 22b including female terminals 18c, 18d and 18e, 18f having at least the identical number of wires. This structure allows for easy-handling of the sub-harnesses H7, H8 of the second wire-harness WH2.

The second connector 22a includes a convex engagement section 20d. The second connector 22b includes a concave engagement section 19e fitted with the convex engagement section 20d. The second connector 22a has four female terminals 18c, 18d. The neighboring female terminals 18c have equal pitches therebetween. The neighboring female terminals 18c, 18d have a pitch P18cd therebetween that is equal to the pitch P7ab. The second connector 22b has five female terminals 18e, 18f. The neighboring female terminals 18d, 18e have a pitch P18de therebetween that is equal to the pitches between the neighboring female terminals 18e and between the neighboring male terminals 7b. The neighboring female terminals 18f have equal pitches therebetween. The female terminals 18e and 18f have a pitch P18ef therebetween that is equal to the pitch P7bc.

The first embodiment includes the three first connectors 10a to 10c and the three second connectors 11a to 11c, and the second embodiment includes the two first connectors and the three second connectors. In addition, the present invention may have a plurality of connectors on both sides. The first and the second wire-harnesses WH1, WH2 may be separated into easily-handled sub-harnesses, having a respective identical number of sub-harnesses.

Although the invention has been described above by reference to certain embodiments of the invention, the invention is not limited to the embodiments described. Modifications and variations of the embodiments described above will occur to those skilled in the art, in light of the above teachings. The scope of the invention is defined with reference to the following claims.

According to the junction connector of the invention, the first and second wire-harnesses are connected to first and second connectors in a wire-harness plant, respectively. One of the first and second connectors is fitted into the corresponding one of the first and second connector-fitting chamber. The first and second wire-harnesses are transferred to a vehicle-body assembly plant, with one of the first and second wire-harnesses mounted on the junction connector. In the vehicle-body assembly plant, the other of the first and second connectors is fitted into the vacant one of the first and second connector-fitting chamber of the junction connector for completion of assembly. Each of the first and second connectors has female terminals, and does not require provision of a hood, to a connector housing, for protecting the female terminals.

In the vehicle-body assembly plant, the assembled one of the first and second connectors is fitted into the corresponding one of the first and second connector-fitting chambers for completion of assembly. This requires one connector-connection operation in the wire-harness assembly plant, thus facilitating connector connection.

1. A junction connector comprising:
a first connector-fitting chamber configured to mate with first connectors, the first connector-fitting chamber having first male terminals connected to first female terminals of the first connectors, respectively;
a second connector-fitting chamber configured to mate with second connectors, the second connector-fitting chamber having second male terminals connected to second female terminals of the second connectors, respectively;
wherein the first male terminals and the second male terminals are connected to each other.

2. The junction connector according to claim 1,
wherein at least one of the first connectors and the second connectors are assembled to each other.

3. A connection structure between wire-harnesses using a junction connector, comprising:
first connectors connected to a first harness and having first female terminals;
second connectors connected to a second harness and having second female terminals; and
a junction connector connecting between the first and second connectors,
the junction connector comprising:
a first connector-fitting chamber mated with the first connectors, the first connector having first male terminals connected to the first female terminals; and
a second connector-fitting chamber mated with the second connectors, the first connector having second male terminals connected to the second female terminals,
wherein the first and second male terminals are connected to each other.

4. The connection structure according to claim 3,
wherein at least one of the first connectors and second connectors are assembled to each other.
